(19) United States
(12) Patent Application Publication
(10) Pub. No.: US 2023/0319419 A1
(43) Pub. Date: Oct. 5, 2023

(54) NETWORK SYSTEM, COMPUTER, AND DEEP LEARNING METHOD

(71) Applicant: JOHNAN Corporation, Uji-shi (JP)

(72) Inventors: Kozo MORIYAMA, Kyoto (JP); Shin KAMEYAMA, Kyoto (JP); Truong Gia VU, Kyoto (JP); Lucas BROOKS, Kyoto (JP)

(21) Appl. No.: 18/188,324

(22) Filed: Mar. 22, 2023

(30) Foreign Application Priority Data
Mar. 30, 2022 (JP) 2022-054849

(51) Int. Cl. H04N 23/695; G06V 20/70; B25J 9/16

(52) U.S. Cl. CPC H04N 23/695; G06V 20/70; B25J 9/1664

(57) ABSTRACT

Provided herein is a network system that includes a three-dimensional camera, a robot arm holding the three-dimensional camera and a computer capable of communicating with the three-dimensional camera and the robot arm. The computer creates three-dimensional shape data of an object by controlling the robot arm and causing the three-dimensional camera to three-dimensionally photograph an external appearance of the object and annotates an image of the object captured by the three-dimensional camera or a camera based on the three-dimensional shape data.

### BACKGROUND OF THE INVENTION

### Field of the Invention

The present invention relates to annotation of deep learning technology.

### Description of the Related Art

In recent years, deep learning is known. For example, Japanese Patent Application Laid-Open No. 2019-029021 discloses a learning data set creation method and an object recognition and position/orientation estimation method. According to Japanese Patent Application Laid-Open No. 2019-029021, a learning data set for performing object recognition and position/orientation estimation of a target object is generated as follows. Object information of an object is associated with a position/orientation detection marker. A learning data set generation jig is used, which is composed of a base portion that serves as a guide for the placement position of the object, and a marker fixed above the base portion. A group of multi-viewpoint images of the entire object including the markers is acquired while the object is arranged using the base portion as a guide. Then, the bounding box of the object is set for the acquired image group. The orientation information and the center-of-gravity position information of the object estimated from the captured image, the object information, and the information on the bounding box are associated with the captured image. In this way, a learning data set for performing object recognition and position/orientation estimation of a target object is generated.

### SUMMARY OF INVENTION

An object of the present invention is to provide a technique for efficient annotation for deep learning.

According to a certain aspect of the present invention, there is provided a network system that includes a three-dimensional camera, a robot arm holding the three-dimensional camera and a computer capable of communicating with the three-dimensional camera and the robot arm. The computer creates three-dimensional shape data of an object by controlling the robot arm and causing the three-dimensional camera to three-dimensionally photograph an external appearance of the object and annotates an image of the object captured by the three-dimensional camera or a camera based on the three-dimensional shape data.

The present invention has enabled efficiently annotating deep learning.

### BRIEF DESCRIPTION OF THE DRAWINGS

FIG. 1 is an image diagram showing the overall configuration of a network system according to the first embodiment.

FIG. 2 is a block diagram of the configuration of the control device according to the first embodiment.

FIG. 3 is a block diagram of a configuration of the camera robot according to the first embodiment.

FIG. 4 is a flow chart showing preparation processing according to the first embodiment.

FIG. 5 is an image diagram showing photo of a first object and point cloud data of the first object according to the first embodiment.

FIG. 6 is an image diagram showing photo of a second object and point cloud data of the second object according to the first embodiment.

FIG. 7 is an image diagram showing photo of a third object and point cloud data of the third object according to the first embodiment.

FIG. 8 is a flow chart showing deep learning process according to the first embodiment.

FIG. 9 is an image diagram showing a bounding box for the first object according to the first embodiment.

FIG. 10 is a flow chart showing preparation processing according to the seventh embodiment.

### DESCRIPTION OF THE PREFERRED EMBODIMENTS

Embodiments of the present invention are described below with reference to the accompanying drawings. In the following descriptions, like elements are given like reference numerals. Such like elements will be referred to by the same names, and have the same functions. Accordingly, detailed descriptions of such elements will not be repeated.

### First Embodiment

### Overall Configuration and Overview of Operation of Network System 1

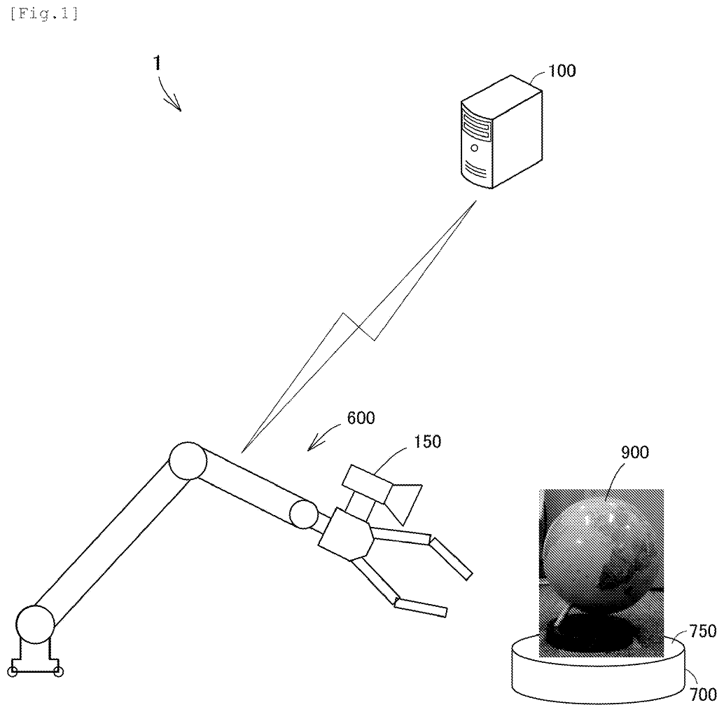

An overall configuration and operation overview of a network system 1 according to the present embodiment is described below, with reference to FIG. 1. Network system 1 includes, mainly, a control device 100, a camera robot 600 and a mounting device 700.

The control device 100 is implemented by a server, a computer, or the like. The control device 100 acquires images from the camera 150 and performs various operations. The control device 100 performs data communication with the camera robot 600 and the mounting device 700 via a wired LAN or wireless LAN.

The camera robot 600 moves the robot arm or the gripper attached to the tip of the robot arm to various positions, rotates it into various postures, and performs various works based on commands from the control device 100 or according to its own judgment.

The mounting device 700 has a mounting table 750 on which an object to be subjected to deep learning or annotation is mounted. The mounting device 700 rotates the mounting table 750 and/or tilts the mounting table 750.

The control device 100 photographs the object 900 mounted on the mounting table 750 from various angles and automatically annotates the object 900. The control device 100 automatically attaches a bounding box to the target object 900 in the captured image. As a result, the control device 100 can perform segmentation of the target object 900 from the captured image.

In this way, the network system 1 according to the present embodiment can reduce the labor of the operator for deep learning. The configuration and operation of each part of the network system 1 will be described in detail below.

### Configuration of Control Device 100

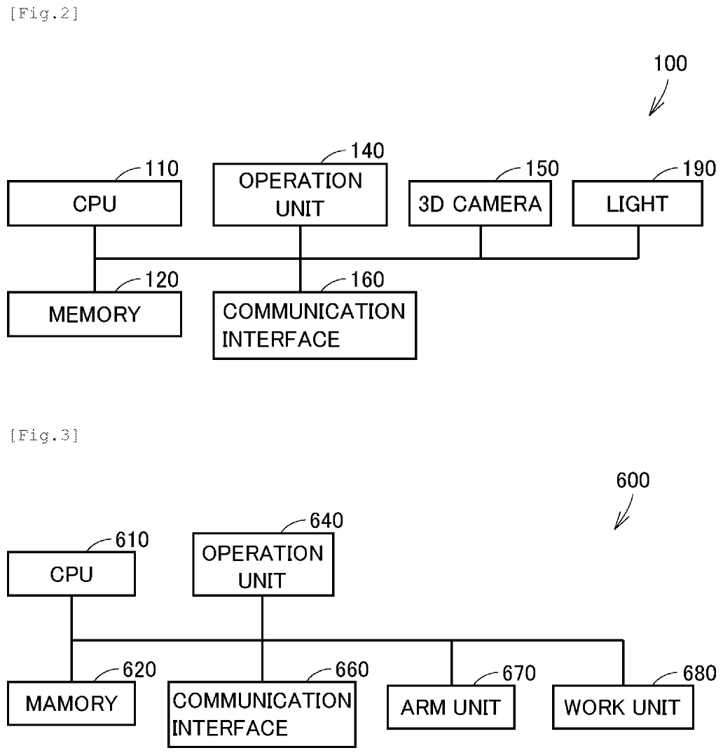

One aspect of the configuration of the control device 100 included in the network system 1 according to the present embodiment will be described. Referring to FIG. 2, control device 100 includes, as main components, CPU (Central Processing Unit) 110, memory 120, operation unit 140, three-dimensional camera 150, communication interface 160, light 190, and the like. CPU 110, memory 120, communication interface 160, etc. implement a computer.

CPU 110 controls each part of control device 100 by executing a program stored in memory 120. For example, CPU 110 executes a program stored in memory 120 and refers to various data to perform various processes described later.

Memory 120 is realized by, for example, various types of RAMS (Random Access Memory) and ROMs (Read-Only Memory). The memory 120 may be included in the control device 100. The memory 120 may be detachable from various interfaces of the control device 100. The memory 120 may be realized by a recording medium of another device accessible from the control device 100. The memory 120 stores programs executed by the CPU 110, data generated by the execution of the programs by the CPU 110, data input from various interfaces, other databases used in this embodiment, and the like.

Operation unit 140 receives commands from users and administrators and inputs the commands to the CPU 110.

Three-dimensional camera 150 includes an RGB-D camera or the like. The three-dimensional camera 150 can acquire the distance to each part of the photographed image by using two cameras, for example. The three-dimensional camera 150 performs three-dimensional imaging or normal 2D imaging based on instructions from the CPU 110. The three-dimensional camera 150 is also simply referred to as the camera 150 below.

Communication interface 160 transmits data from CPU 110 to camera robot 600 via a wired LAN, wireless LAN, internet, mobile communication network, or the like. Communication interface 160 receives data from camera robot 600 and transfers the data to CPU 110.

Light 190 emits light in front of the camera 150 according to instructions from the CPU 110.

### Configuration of Camera Robot 600

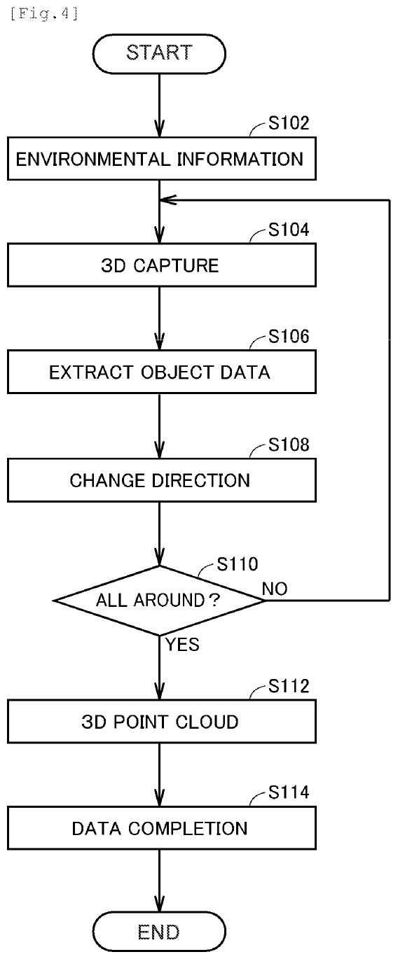

Next, one aspect of the configuration of the camera robot 600 included in the network system 1 will be described. Referring to FIG. 3, camera robot 600 according to the present embodiment includes, as main components, CPU 610, memory 620, operation unit 640, communication interface 660, arm unit 670, working unit 680, and the like.

CPU 610 controls each part of the camera robot 600 by executing various programs stored in the memory 620.

Memory 620 is implemented by various RAMS, various ROMs, and the like. Memory 620 stores various application programs, data generated by execution of programs by CPU 610, operation commands given from control device 100, data input via various interfaces, and the like.

Operation unit 640 includes buttons, switches, and the like. The operation unit 640 receives various commands input by the user and transfers the various commands to the CPU 610.

Communication interface 660 transmits and receives data to and from other devices such as control device 100 via a wired LAN, wireless LAN, internet, mobile communication network, router, or the like. For example, communication interface 660 receives an operation command from control device 100 and passes it to CPU 610.

Arm unit 670 has three-dimensional camera 150 and working unit 680. Three-dimensional camera 150 and working unit 680 are attached to the tip of the arm part 670. Arm unit 670 controls the position and posture of three-dimensional camera 150 and the position and posture of working unit 680 in accordance with instructions from CPU 610.

Working unit 680 performs various operations, such as grasping, releasing an object and using tools, according to instructions from CPU 610.

### Information Processing of Control Device 100

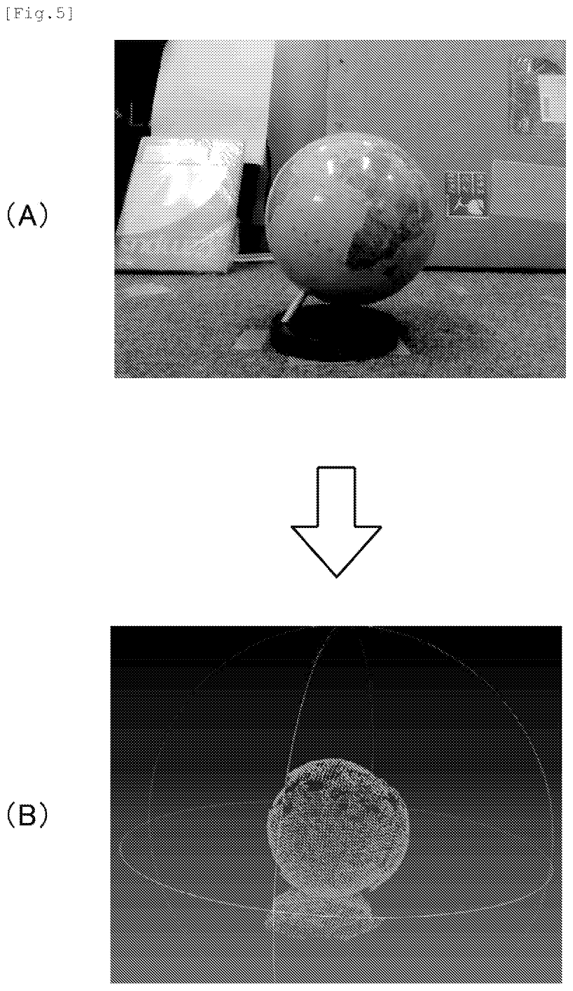

Next, referring to FIG. 4, information processing of control device 100 in the present embodiment will be described in detail. As a computer, CPU 110 of control device 100 executes deep learning preparation processing shown in FIG. 4.

In advance, the CPU 110 receives three-dimensional CAD data such as three-dimensional shape information and position information of the surrounding environment (table, stage, robot itself, etc.) and registers them in the memory 120 (step S102).

CPU 110 causes the camera 150 such as an RGB-D camera attached to arm unit 670 of the camera robot 600 to photograph the object 900 and obtains an RGB+Depth MAP (step S104). Here, CPU 110 can calculate the posture information of the camera 150 from the posture information of the camera robot 600 and the arm unit 670.

CPU 110 subtracts the data of the surrounding objects registered in step S102 from the RGB+Depth MAP imaged in step S104 to obtain three-dimensional information of only the object 900 (step S106).

CPU 110 moves and rotates arm unit 670 of camera robot 600 and rotates and tilts the mounting table 750 (step S108) to photograph the object from other angles (step S104). In other words, CPU 110 repeats the processing from step S104 until the three-dimensional imaging from the entire 360-degree circumference of the object 900 is completed (YES in step S110).

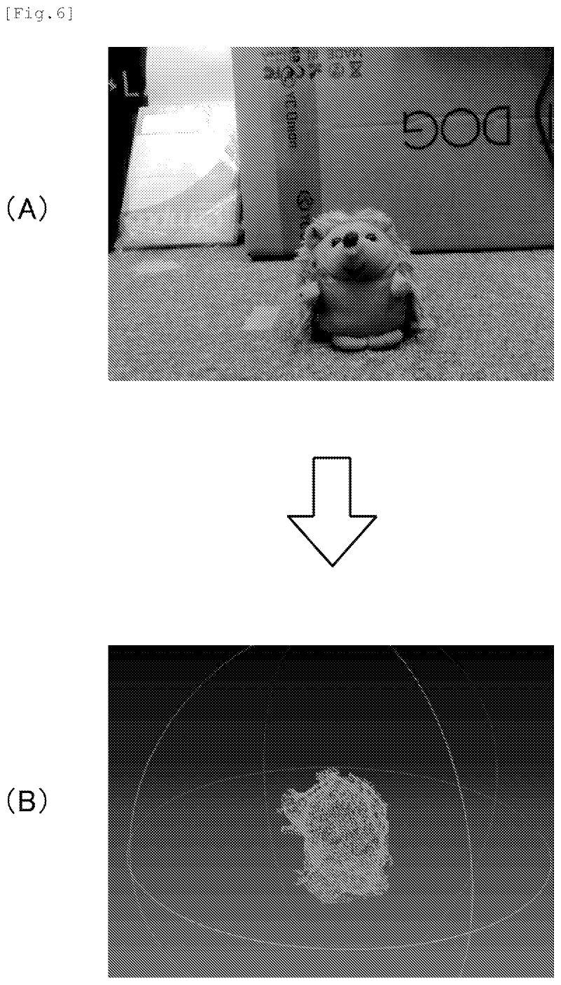

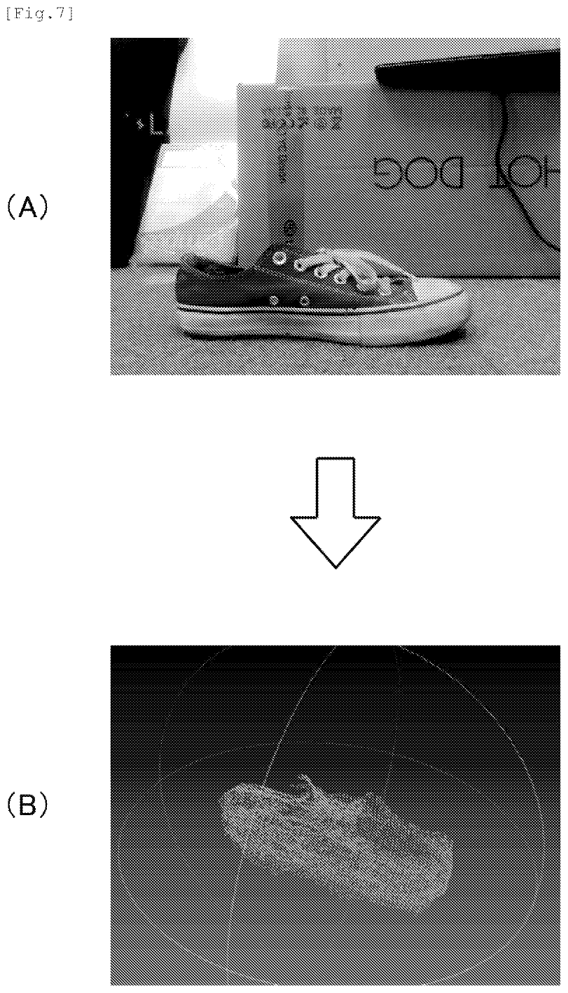

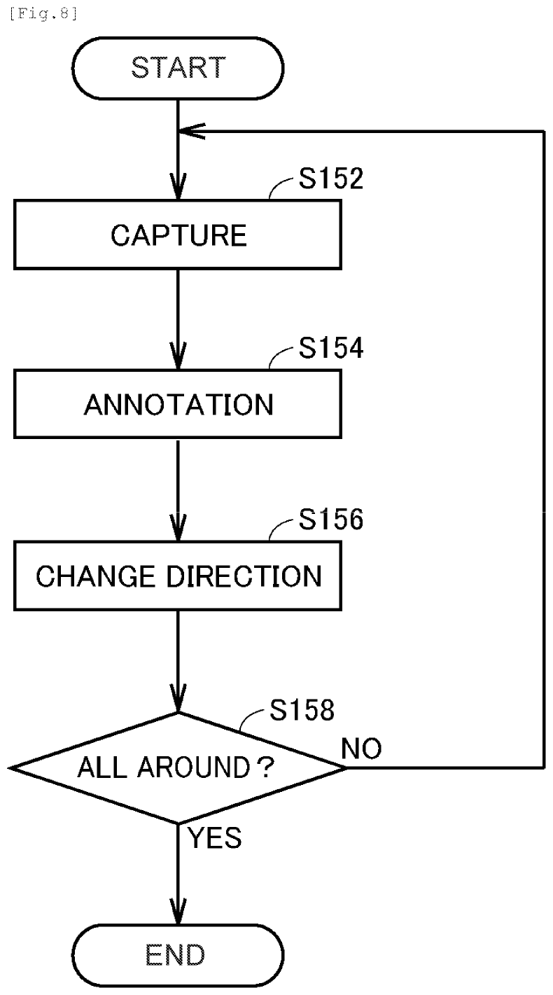

The CPU 110 creates three-dimensional point cloud data of the object 900 from the RGB+Depth MAP for 360 degrees of the object 900 (step S112). Specifically, the CPU 110 creates three-dimensional point cloud data from the three-dimensional captured image of the object, as shown in FIGS. 5, 6, and 7.

Based on the point cloud data created in step S112, the CPU 110 searches for places where the point group is insufficient and/or where there is noise. The CPU 110 moves the arm unit 670 so that the camera 150 can photograph the place in greater detail. Preferably, the CPU 110 takes additional images with the camera 150 and resynthesizes the three-dimensional point cloud data (step S114).

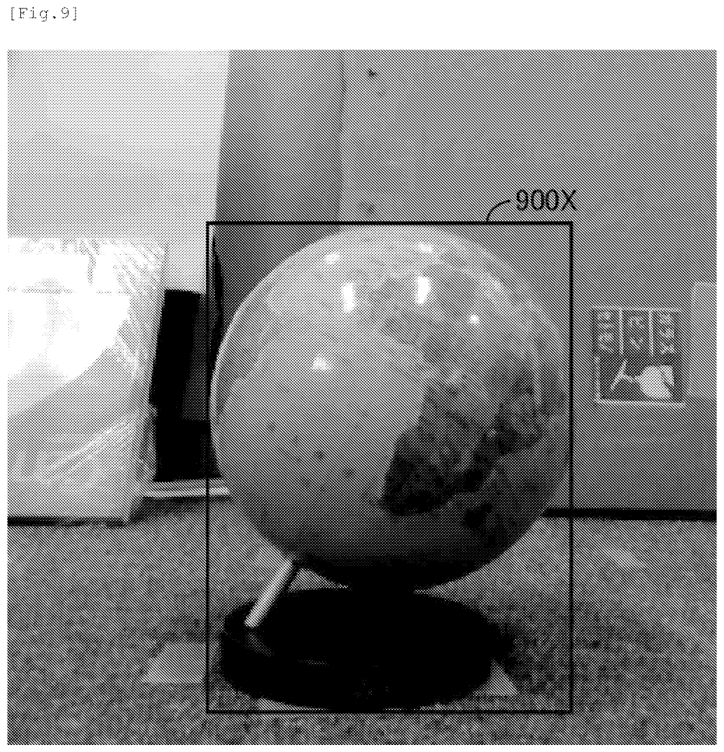

After step S114, CPU 110 of control device 100 subsequently executes the process shown in FIG. 8 according to the program in memory 120, as deep learning process.

CPU 110 causes the camera 150 attached to the arm unit 670 of the camera robot 600 to two-dimensionally photograph the object 900 (step S152).

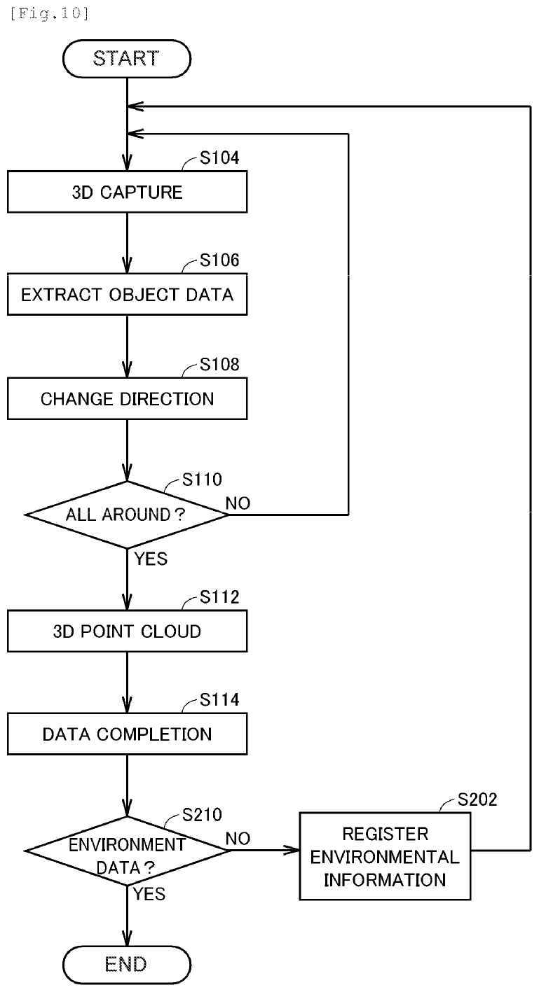

CPU 110 calculates the appearance of the object 900, based on the position information and orientation information of the robot 600 and the arm section 670, the position information and orientation information of the object 900, and the three-dimensional point cloud data of the object 900 (step S154). CPU 110 automatically creates annotation information based on the position information and orientation information of the robot 600 and the arm section 670, the position information and orientation information of the object 900, and the three-dimensional point cloud data of the object 900 (step S154). In the present embodiment, as shown in FIG. 9, based on the three-dimensional point cloud data of object 900 and the imaging direction of camera 150, CPU 110 generates, as annotation information, a bounding box 900X that circumscribes object 900, the outline of the object 900, and the like.

CPU 110 moves and/or rotates the arm portion 670 of the robot 600 and rotates and/or tilts the mounting table 750 (step S156). CPU 110 photographs the object from other angles (step S152). That is, CPU 110 repeats the processing from step S152 until the two-dimensional imaging of the entire 360-degree circumference of the object 900 is completed (step S158).

### Second Embodiment

In addition to the above embodiments, the CPU 110 may use a recognition result using deep learning of the object 900 based on annotation information automatically created before. After that, the CPU 110 may calculate, based on the captured image including the target object 900, the degree of similarity between the annotation information of the target object 900 calculated in step S152 and the information recognized by deep learning. When the degree of similarity is large, CPU 110 preferably performs annotation processing intensively with greater emphasis on angles close to similar angles.

### Third Embodiment

In addition to the above embodiments, lights may be arranged on the robot 600, the mounting device 700, the ceiling, the wall surface, and the like. Then, in step S156, the CPU 110 moves or rotates the arm unit 670 of the robot 600, rotates or tilts the mounting table 750, turns the light 190 on/off, changes the intensity of the light 190 and/or changes the color of the light of the light 190 (step S156). In this changing situation, the CPU 110 takes an image from various angles (step S152). That is, the CPU 110 repeats the processing from step S152 until the two-dimensional imaging of 360 degrees around the object 900 in various light conditions is completed (step S158).

### Fourth Embodiment

In addition to the above embodiments, the working unit 680 mounted on the robot 600 may change the orientation and posture of the object. In this case, since the three-dimensional shape of the object changes, CPU 110 associates information on the changed orientation/attitude of the object with information on the three-dimensional shape of the object at that time. The CPU 110 stores the related information in the memory 120 separately for each posture of the object.

CPU 110 reads the orientation and posture of the object stored in memory 120 when executing the deep learning process (steps 5152 to S158). The CPU 110 uses the working unit 680 of the robot 600 so that the orientation and posture of the object match the registered state. After that, the CPU 110 performs deep learning processing (steps S152 to S158).

### Fifth Embodiment

In the above embodiment, the CPU 110 causes the robot 600 to perform two-dimensional imaging in step S152, but the CPU 110 may cause the robot 600 to perform three-dimensional imaging. The CPU 110 may add annotation information to each piece of three-dimensional image data based on the three-dimensional point cloud data (step S154).

### Sixth Embodiment

In the above-described embodiment, CPU 110 also uses the three-dimensional camera 150 used in the preparatory process shown in FIG. 4 to take images for the deep learning process shown in FIG. 8. However, CPU 110 may use a camera different from the three-dimensional camera 150 used in the preparatory process shown in FIG. 4 for photographing for the deep learning process shown in FIG. 8.

### Seventh Embodiment

In the above embodiment, CPU 110 receives three-dimensional CAD data such as three-dimensional shape information and position information of the surrounding environment (table, stage, robot itself, etc.) and registers the information in the memory 120. However, the CPU 110 may also acquire the three-dimensional information of the surrounding environment from the image captured by the camera, like the object.

More specifically, in the present embodiment, referring to FIG. 10, in advance, CPU 110 performs a method similar to the method of acquiring object information shown in FIG. 4 to acquire the three-dimensional information of the surrounding environment (steps S104 to S105). If the environment information is not registered (NO in step S210), the CPU 110 registers the obtained three-dimensional information in the memory 120 as environment data (step S202).

After that, in the same manner as in the first embodiment, the CPU 110 repeats the processing from step S104 until the three-dimensional imaging of all 360 degrees around the object 900 is completed (step S110).

### Eighth Embodiment

Other devices may perform part or all of the role of each device such as control device 100 and camera robot 600 of the network system 1 of the above embodiment. For example, camera robot 600 may play a part of the role of control device 100. A plurality of personal computers may play the role of the control device 100. Information processing of the control device 100 may be executed by a plurality of servers on the cloud.

### Review

The foregoing embodiments provide a network system that includes a three-dimensional camera, a robot arm holding the three-dimensional camera and a computer capable of communicating with the three-dimensional camera and the robot arm. The computer creates three-dimensional shape data of an object by controlling the robot arm and causing the three-dimensional camera to three-dimensionally photograph an external appearance of the object and annotates an image of the object captured by the three-dimensional camera or a camera based on the three-dimensional shape data.

The foregoing embodiments provide a computer that includes a communication interface for communicating with a three-dimensional camera and a robot arm, a memory and a processor. The processor creates three-dimensional shape data of an object by controlling the robot arm and causing the three-dimensional camera to three-dimensionally photograph an external appearance of the object and annotates an image of the object captured by the three-dimensional camera or a camera based on the three-dimensional shape data.

The foregoing embodiments provide a deep learning method that includes a first step of controlling a robot arm to move a three-dimensional camera around a object, a second step of three-dimensionally photographing an external appearance of the object, a third step of creating three-dimensional shape data of the object by repeating the first step and the second step, a fourth step of photographing the object by the three-dimensional camera or a camera and a fifth step of annotating an image of the object captured by the three-dimensional camera or the camera based on the three-dimensional shape data.

The embodiments disclosed herein are to be considered in all aspects only as illustrative and not restrictive. The scope of the present invention is to be determined by the scope of the appended claims, not by the foregoing descriptions, and the invention is intended to cover all modifications falling within the equivalent meaning and scope of the claims set forth below.

What is claimed is:

1. A network system comprising:
a three-dimensional camera;
a robot arm holding the three-dimensional camera; and
a computer capable of communicating with the three-dimensional camera and the robot arm, wherein
the computer creates three-dimensional shape data of an object by controlling the robot arm and causing the three-dimensional camera to three-dimensionally photograph an external appearance of the object and annotates an image of the object captured by the three-dimensional camera or a camera based on the three-dimensional shape data.

2. A computer comprising:
a communication interface for communicating with a three-dimensional camera and a robot arm;
a memory; and
a processor, wherein
the processor creates three-dimensional shape data of an object by controlling the robot arm and causing the three-dimensional camera to three-dimensionally photograph an external appearance of the object and annotates an image of the object captured by the three-dimensional camera or a camera based on the three-dimensional shape data.

3. A deep learning method comprising:
a first step of controlling a robot arm to move a three-dimensional camera around an object;
a second step of three-dimensionally photographing an external appearance of the object;
a third step of creating three-dimensional shape data of the object by repeating the first step and the second step;
a fourth step of photographing the object by the three-dimensional camera or a camera; and
a fifth step of annotating an image of the object captured by the three-dimensional camera or the camera based on the three-dimensional shape data.
